(19) United States
(12) Patent Application Publication
(10) Pub. No.: US 2009/0122241 A1
(43) Pub. Date: May 14, 2009

(54) LIQUID CRYSTAL DISPLAY DEVICE AND MANUFACTURING METHOD OF THE SAME

(76) Inventor: Hitoshi Satoh, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/298,224

(22) PCT Filed: Feb. 21, 2007
(86) PCT No.: PCT/JP2007/053219

§ 371 Date: Oct. 23, 2008

(30) Foreign Application Priority Data
Apr. 28, 2006 (JP) 2006-125657

(51) Int. Cl. G02F 1/1339; G02F 1/1335; G02F 1/1333

(52) U.S. Cl. 349/106; 349/155; 349/187

(57) ABSTRACT

A liquid crystal display device is provided with a TFT substrate 10, a CF substrate 20, spacer beads 31, and liquid crystal 32. The TFT substrate 10 and the CF substrate 20 are assembled in parallel. The spacer beads 31 hold the two substrates 10, 20 at a desired distance. The liquid crystal 32 is sealed between the two substrates 10, 20. Protrusions 18 are formed on an opposing surface to the CF substrate 20 of the TFT substrate 10. The protrusions 18 each enclose whole peripheries of respective distribution areas 17 arranged for disposing the spacer beads 31 therein. Therefore, when ink containing the spacer beads 31 is applied into the distribution area 17, the spacer beads do not move out of the distribution area 17. The spacer beads 31 are thus reliably disposed in the distribution area 17.

### TECHNICAL FIELD

The present invention relates to a liquid crystal display device and a manufacturing method of the same. More specifically, the present invention relates to a liquid crystal display device that maintains a space between transparent substrates with spacer beads, and a manufacturing method of the liquid crystal display device.

### BACKGROUND ART

Liquid crystal display devices are constituted by transparent substrates that are made of glass and have TFT (thin film transistors) formed thereon, transparent substrates that are made of glass and have RGB distributed thereon and thereby configuring color filters, and liquid crystal that is held between the substrates. In order to prevent display unevenness and the like, it is required for such a liquid crystal panel that a liquid crystal layer, or a cell gap, be uniform in thickness. Devices to make the uniform cell gap have been manufactured, one example of which is a device having spherical spacer beads as disclosed in Patent Document 1, wherein the spacer beads are disposed between the transparent substrates and thus arranged to maintain a uniform distance between the transparent substrates over the whole surfaces of the substrates.

[Patent Document 1] Japanese Unexamined Patent Application Publication No. 2005-10412

### DISCLOSURE OF THE INVENTION

However, if the spherical spacer beads enter a display area of the liquid crystal display device, they can cause disarray in alignment of liquid crystal molecules in the display area, which results in trouble in lower display quality. It is therefore expected that the spacer beads be allocated as within a light shield area that is not involved in image display as possible. However, it is difficult to allocate the spherical spacer beads at preferred places such as the light shield area.

The present invention was achieved in accordance with the circumstances as above, and its purpose is to provide a liquid crystal display device having the spacer beads disposed at the expected places.

As a means for achieving the purpose as above, a liquid crystal display device in accordance with the present invention includes a pair of transparent substrates, a spacer bead that holds the pair of transparent substrates at a desired distance, and liquid crystal sealed between the pair of transparent substrates. The liquid crystal display device is characterized in that a distribution area and a protrusion are formed on an opposed surface of one of the pair of transparent substrates to another one of the transparent substrates. The spacer bead is disposed in the distribution area, and the protrusion substantially encloses a whole periphery of the distribution area.

In addition, a method of manufacturing a liquid crystal display device in accordance with the present invention is characterized by the steps of: providing a protrusion on an opposed surface of at least one of a pair of transparent substrates to another one of the pair of transparent substrates, the protrusion substantially enclosing the whole periphery of a distribution area that is arranged for disposing a spacer bead therein; applying the spacer bead together with ink into the distribution area enclosed with the protrusion on the one of the transparent substrates; vaporizing the ink, thereby securing the spacer bead onto the distribution area; assembling the pair of transparent substrates with holding the spacer bead therebetween and thereby spacing a desired distance therebetween; and dispensing or sealing the liquid crystal in a space between the assembled pair of transparent substrates.

In accordance with the present invention, since the whole periphery of the distribution area to dispose the spacer bead is substantially enclosed by the protrusion, the spacer bead in the distribution area is prevented from moving out of the distribution area.

### BRIEF DESCRIPTION OF THE DRAWINGS

FIG. 1 is an enlarged partial plan view of a TFT substrate of a first embodiment;

FIG. 2 is an enlarged sectional view taken along line X-X of FIG. 1;

FIG. 3 is an enlarged partial plan view of a CF substrate of a second embodiment;

FIG. 4 is a sectional view taken along line Y-Y of FIG. 3;

FIG. 5 is a sectional view taken along line Z-Z of FIG. 5; and

FIG. 6 is an enlarged partial plan view of a TFT substrate of a third embodiment.

### EXPLANATION OF NUMERALS

10 . . . a TFT substrate (a transparent substrate)
17 . . . a distribution area
18 . . . a protrusion
19 . . . a rib
20 . . . a CF substrate (a transparent substrate)
21 . . . a color filter
22 . . . a colored portion
23 . . . a light shield black layer
25 . . . an alignment layer
31 . . . a spacer bead
32 . . . liquid crystal
40 . . . a distribution area
41 . . . a protrusion
42a, 42b . . . a rib
43 . . . a raised portion
44 . . . an inclined surface
45 . . . a tapered face
50 . . . a distribution area
51 . . . a supplemental capacitor line
52 . . . a protrusion

### BEST MODE FOR CARRYING OUT THE INVENTION

### First Embodiment

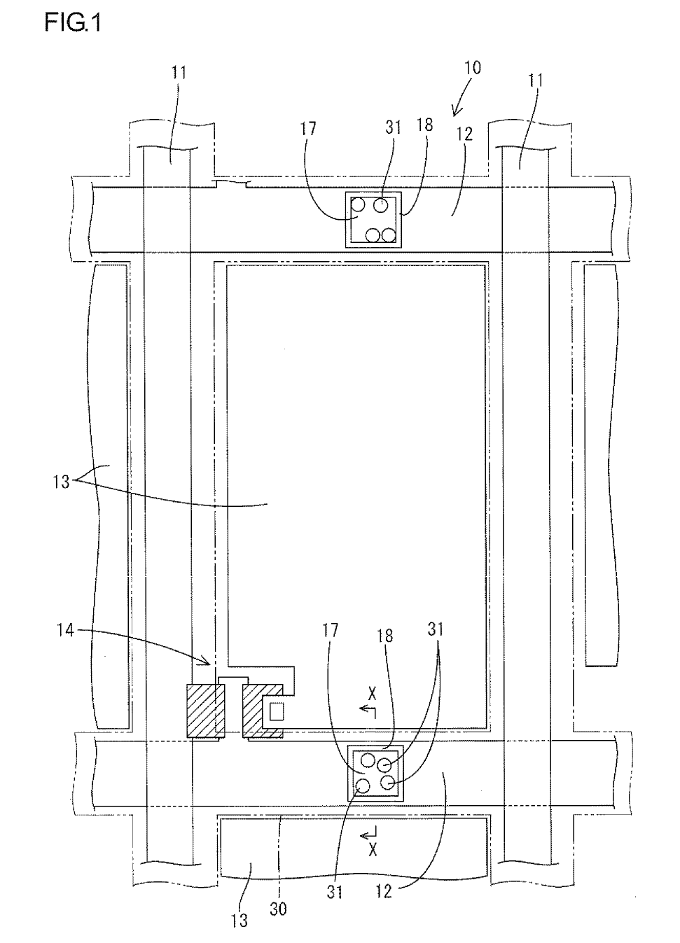

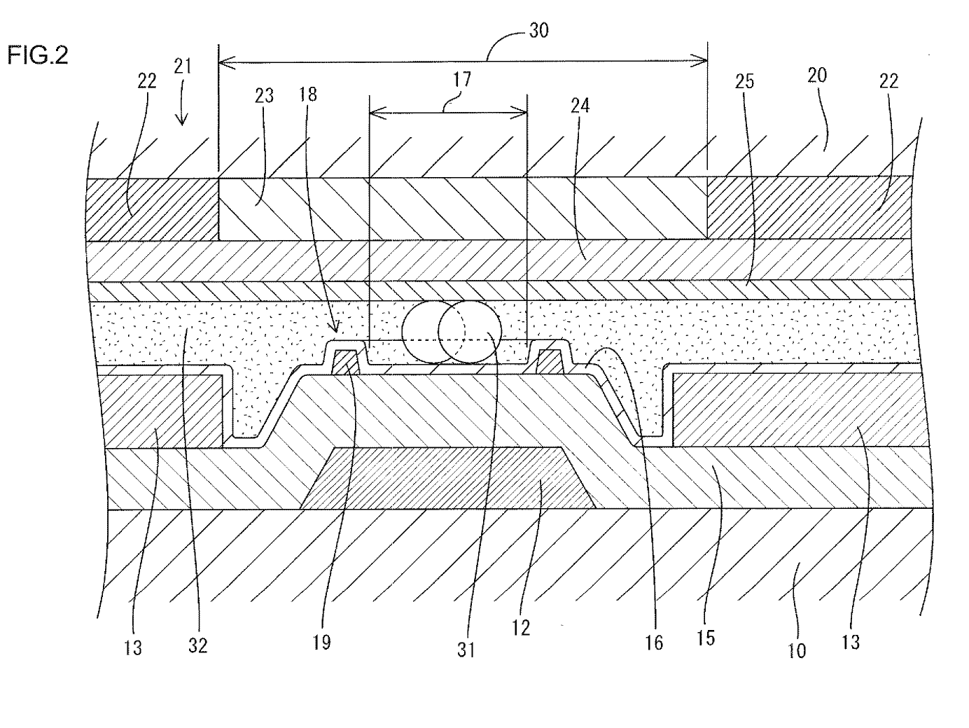

A first embodiment in accordance with the present invention will be explained with reference to FIGS. 1 and 2. A liquid crystal display device of this first embodiment includes a pair of transparent substrates made of glass, spacer beads 31, and liquid crystal 32. The transparent substrates are a TFT substrate 10 and a CF substrate 20. The TFT substrate 10 and the CF substrate 20 are assembled together in parallel. The spacer beads 31 intervene between the two substrates 10, 20, thereby maintaining a uniform distance (an even cell gap) between the two substrates 10, 20 over the whole surfaces of the two substrates 10, 20. The liquid crystal 32 is dispensed or sealed in a space between the two substrates 10, 20. The space is thus filled with the liquid crystal.

As shown in FIG. 1, a plurality of source lines 11 longitudinally run at equal intervals on an opposed surface to the CF substrate 20 of the TFT substrate 10, and a plurality of gate lines 12 laterally run at equal intervals on the same surface of the TFT substrate 10. The source lines 11 and the gate lines 12 configure a grid-pattern of a plurality of square frames (FIG. 1 shows only one of the frames). A display electrode 13 is disposed in each of the frames. The display electrodes 13 are made of ITO (indium tin oxide) and are transparent. Each of the display electrodes 13 has a generally square thin plate shape. In addition, a switching element 14 is provided in a corner of each of the frames. Each of the switching elements 14 includes a TFT (a thin film transistor). The switching elements 14 are connected to the source lines 11 and the gate lines 12. The gate lines 12 are connected to the driving elements 14. Note that, as shown in FIG. 2, an insulation layer 15 is formed on the surface (the opposed surface to the CF substrate 20) of the TFT substrate 10 and on the surfaces of the gate lines 12. The display electrodes 13 are formed on a surface of the insulation layer 15. In addition, an alignment layer 16 is formed on a surface of the display electrode 13.

On the other hand, a color filter 21 is provided on an opposed surface to the TFT substrate 10 of the CF substrate 20. The color filter 21 is constituted by aligning and allocating a plurality of colored portions 22 in a matrix. The colored portions 22 consists of three primary colors, i.e. red (R), green (G), and blue (B). A light shield black layer 23 (a black matrix) is formed on the same surface of the CF substrate 20. The light shield black layer 23 is disposed in a grid pattern between adjacent ones of the colored portions 22 and around an area where the colored portions 22 are allocated (on an outer perimeter of the CF substrate) so as to prevent light leakage. The light shield black layer 23 partitions the colored portions 22. In addition, a thin plate-shaped common electrode 24 is formed on surfaces of the color filter 21 and the light shield black layer 23 (on the opposed surface to the TFT substrate 10). The common electrode 24 is made of ITO (indium tin oxide) and is transparent. Formed on a surface of the common electrode 24 is an alignment layer 25.

A grid-patterned area on the CF substrate 20 where the light shield black layer 23 is formed corresponds to a grid-patterned area on the TFT substrate 10 where the source lines 11 and the gate lines 12 run. The grid-patterned area defined by the light shield black layer 23 constitutes a light shield area 30 that is not involved in image display in the liquid crystal display device. Both of the source lines 11 and the gate lines 12 are disposed in the light shield area 30. The surface opposed to the CF substrate (the surface) of the TFT substrate 10 is provided with distribution areas 17. The distribution areas 17 are arranged for disposing the spacer beads 31. The distribution areas 17 are located on the gate lines 12 extending in a strip shape. A planar shape of each of the distribution area 17 is square that orients two of the four sides parallel to a longitudinal direction of respective one of the gate line 12.

In addition, protrusions 18 are formed on the surface of the TFT substrate. Each of the protrusions 18 is disposed along an outer perimeter of respective one of the distribution areas 17. The protrusion 18 entirely encloses a whole periphery of the distribution area 17. A planar shape of the protrusion is, similar to the distribution area, square. Two of the four sides of the protrusion 18 is parallel to the gate line 12 and are disposed along two side edges of the gate line 12. The protrusion 18 includes ribs 19 formed on a surface of the insulation layer 15. A planar shape of the ribs 19 is square (that is, the ribs 19 includes a pair of ribs 19 which are parallel to the longitudinal direction of the gate line 12 and a pair of ribs 19 which are parallel to a widthwise direction (perpendicular to the longitudinal direction) of the gate line 12). A transverse sectional shape perpendicular to the longitudinal direction of each of the ribs 19 is trapezoidal. In this embodiment, aiming at the configuration that the distribution areas 17 are disposed on the gate lines 12 and that the source lines 11 cross the surface of the gate lines 12 (the surface of the insulation layer 15) in overlapping relation, the ribs 19 are made of the same material as the source lines 11. That is, the ribs 19 are simultaneously formed with the source lines 11 by photolithography process during a forming process of the source lines 11. Note that outer surfaces (the upper and side surfaces) of the ribs 19 are covered with the alignment layer 16.

The distribution areas 17 are enclosed with the protrusions 18 as described above, and the plurality of spacer beads 31 are disposed in the distribution areas 17. That is, in this embodiment, the gate lines 12 connected to the driving elements 14 are utilized to dispose the spacer beads 31. The spacer beads 31 are spherical bodies made of synthetic resin, and the surfaces of the spacer beads 31 are coated with adhesive (not illustrated).

Note that each of the gate lines 12 has a widthwise dimension of 25 to 60 μm. In a case that the gate line 12 has a widthwise dimension of 25 μm, the distribution area 17 can be set to approximately 20 μm in length per a side thereof. In addition, each of the spacer beads 31 is approximately 3 μm in diameter, and the protruding dimension (the height dimension from the surface of the distribution area 17 wherein the spacer beads 31 are placed) of each of the protrusions 18 is approximately 0.2 μm. In addition, the transverse sectional shape of the protrusion 18 is, similar to the rib 19, a trapezoid which widthwise dimension is shorter on the upper side. The upper side of the protrusion 18 has a widthwise dimension (the dimension including the alignment layer 16) of approximately 4.0 μm.

In a manufacturing processes of the liquid crystal display device, ink (not illustrated) containing the spacer beads 31 is delivered from an inkjet apparatus (not illustrated) and thereby applied to the surfaces of the distribution areas 17. Then, since a drop of the ink contains a plurality of the spacer beads 31, the plurality of spacer beads 31 are applied into each of the distribution areas 17.

The applied ink gradually vaporizes to dry, with maintaining the shape of a single drop by surface tension. The ink drop thus gradually gets smaller in diameter. As the ink drop is getting smaller in diameter, the plurality of spacer beads 31 contained in the ink move on a placing surface of the distribution area 17, while coming closer to each other. Then, since the whole periphery of the distribution area 17 is enclosed with the protrusion 18 like a barrier, the spacer beads 31 in the distribution area 17 cannot move out of the distribution area 17. Finally, when the ink has completely vaporized, the spacer beads 31 are secured to the placed surface of the distribution area by the adhesive applied on the surface of the spacer beads.

Note that, even if the ink drop applied toward the distribution area 17 partially hits onto the protrusion 18 and the spacer beads 31 rise up to the upper surface of the protrusion 18, the spacer beads 31 which have risen up to the upper surface of the protrusion 18 are drawn to the spacer beads 31 which are located in the distribution area 17 (i.e. the spacer beads 31 which are caught by the protrusion 18 and thereby restricted in movement out of the distribution area 17) while the ink drop is decreasing. This result in the spacer beads on the upper surface of the protrusion 18 being disposed within the distribution area 17.

Once the spacer beads 31 are disposed on (secured to) the surface of the TFT substrate 10 as described above, the TFT substrate 10 and the CF substrate 20 are assembled together (glued together), with holding the spacer beads 31 therebetween. The spacer beads 31 secured to the plurality of the distribution areas 17 then maintain the even space (the cell gap) between the two substrates 10, 20 over the whole area on the two substrates 10, 20. This results in the two substrates 10, 20 being maintained in parallel with higher accuracy. After then, processes such as a dispensing or sealing process of the liquid crystal 32 in the space between the two substrates 10, 20 are operated with using a liquid crystal dispenser (not illustrated) and the like. Manufacture of the liquid crystal display device is thus processed.

As described above, in this embodiment, the whole peripheries of the distribution areas 17 to dispose the spacer beads 31 are enclosed with the protrusions 18. The spacer beads 31 applied in the distribution areas 17 are therefore prevented from moving out of the distribution areas 17. Positioning accuracy of the spacer beads 31 is thus higher.

Furthermore, the whole peripheries of the distribution areas 17 are entirely enclosed with the protrusions 18. The spacer beads 31 are therefore reliably prevented from moving out of the distribution areas 17.

In addition, in this embodiment, the ribs 19 that configure the protrusions 18 are arranged to be formed by the same process as the source lines 11.

### Second Embodiment

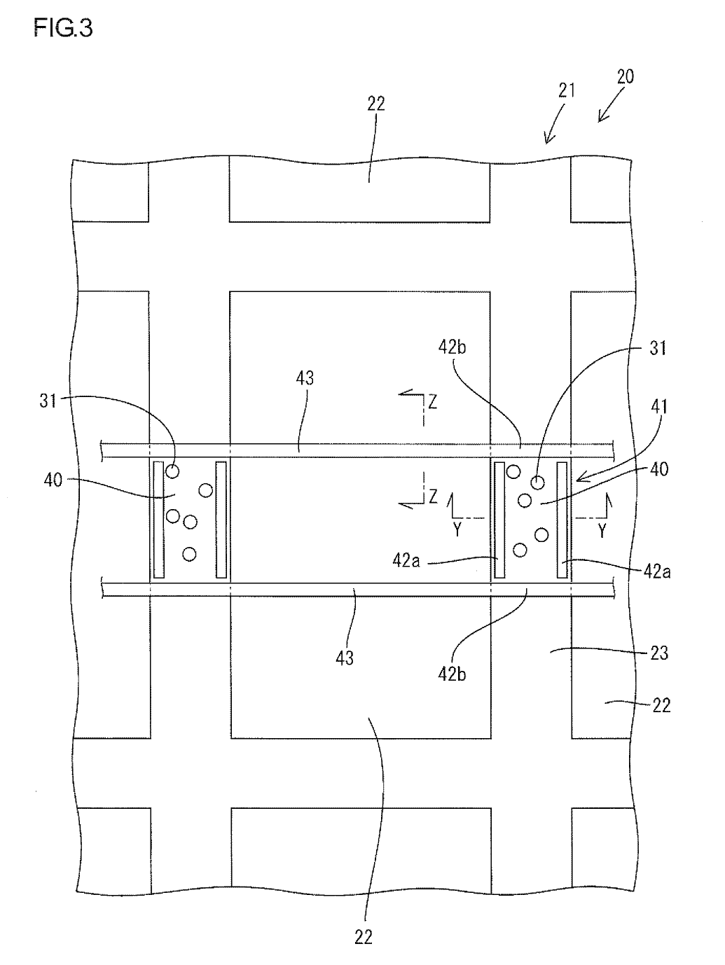

A second embodiment in accordance with the present invention will be now described with reference to FIGS. 3 through 5. In this second embodiment, the spacer beads 31 are disposed on the CF substrate 20 only, instead of on the TFT substrate 10. Similar configurations to the above first embodiment are designated by the same numerals, while explanations on the configurations, operations and effects are omitted.

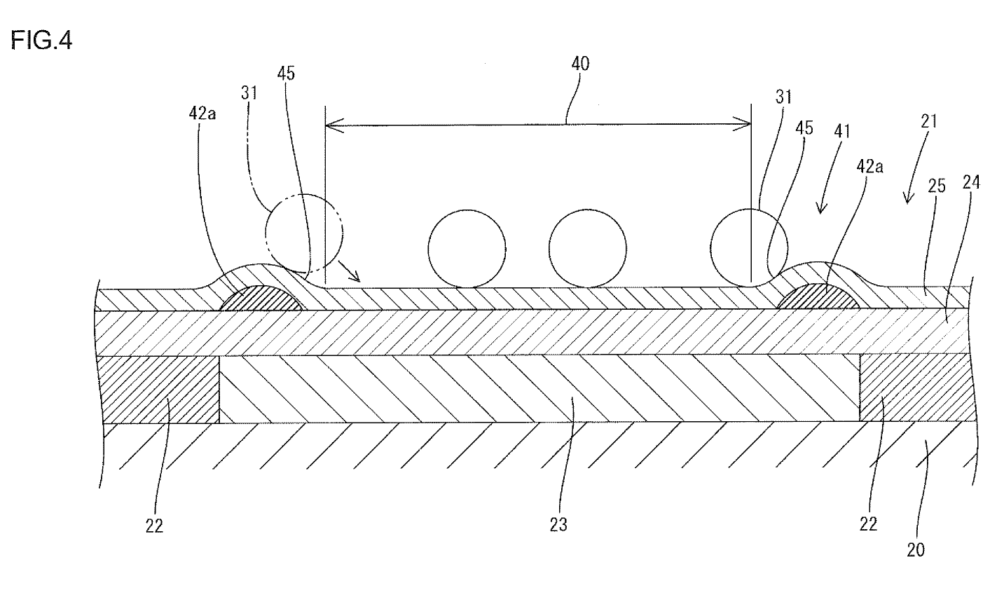

Note that, in FIG. 4, the opposed surface of the CF substrate 20 to the TFT substrate 10 is illustrated as an upper surface. In this second embodiment, distribution areas 40 are ensured to be in an area which corresponds to the light shield black layer 23 (specifically, an area which corresponds to the source lines 11) in the light shield area 30. The planar shape of each of the distribution area 40 is rectangular. A surface of the distribution area 40 is covered with the alignment layer 25, and the spacer beads 31 are secured to a surface of the alignment layer 25. That is, the light shield black layer 23 that partitions the plurality of colored portions 22 is utilized to dispose the spacer beads 31.

A whole periphery of each of the distribution area 40 is substantially enclosed with a protrusion 41. The protrusion 41 is configured in a generally rectangular shape by four ribs 42a, 42b. The ribs 42a, 42b each are disposed along respective four sides of the distribution area 41. The ribs 42a, 42b do not make any contact with each other, and the rectangular shape formed by the protrusion 41 is gapped at the four corners thereof. A distance between the ribs 42a and 42b at each of the gapped portion is sufficiently smaller than the diameter of any one of the spacer beads 31. The ribs 42a are parallel to a longitudinal direction of the light shield black layer 23, while the ribs 42b are perpendicular to the longitudinal direction of the light shield black layer 23. Surfaces of the ribs 42a, 42b are covered with the alignment layer 25.

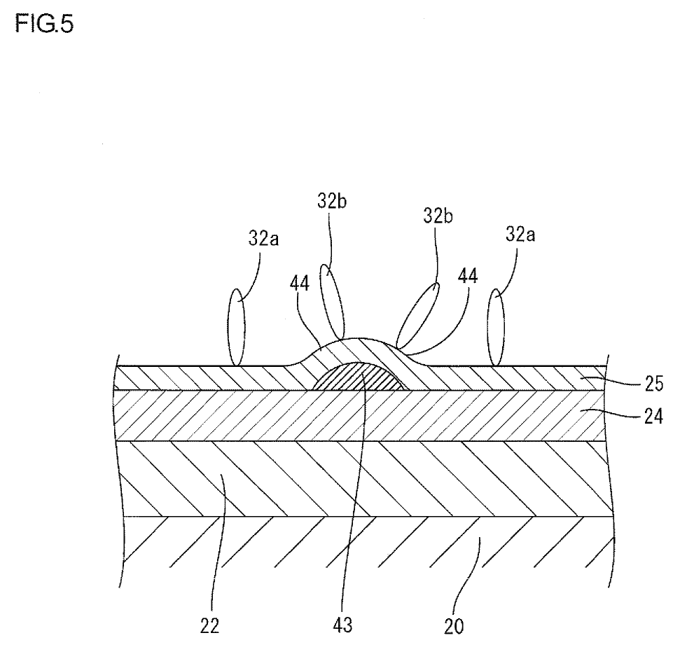

In addition, while the ribs 42a, 42b are formed on the surface (the opposite surface to the TFT substrate 10) of the common electrode 24, raised portions 43 are formed on the surface of the common electrode 24 and in an area (the outside of the light shield area 30) which corresponds to the colored portions 22. Each of the raised portions 43 has a long and thin shape. The raised portions 43 cross the source lines 11 perpendicular to the longitudinal direction of the source lines 11. The raised portions 43 also extend across the colored portions 22. Each of the raised portions 43 is arcuate in transverse section, as shown in FIG. 5, and the surface is arcuately curved. While the alignment layer 25 is overlaid on the surfaces of the colored portions 22 (more exactly, on the surface of the common electrode), the raised portions 43 are formed by partially raising the alignment layer 25 to form inclined surfaces 44. The inclined surfaces 44 are inclined with respect to the CF substrate 20. While liquid crystal molecules 32a, 32b are disposed on the alignment layer 25, the liquid crystal molecules 32a that are disposed on an area other than the raised portions 43 and the liquid crystal molecules 32b that are disposed on the inclined surfaces 44 orients different directions from each other.

In this embodiment, the ribs 42a, 42b are made of the same type of synthetic resin as the raised portions 43. That is, the ribs 42a, 42b are simultaneously formed with the raised portions 43 by photolithography process during a forming process of the raised portions 43. In addition, while the raised portions 43 include areas that cross the light shield black layer 23, the ribs 42b that are perpendicular to the longitudinal direction of the light shield black layer 23 combines the areas. That is, the raised portions 43 each are partially configured by the respective ribs 42b. In addition, outer surfaces (upper and side surfaces) of the ribs 42a, 42b are covered with the alignment layer 25. In addition, while the ribs 42b have the same transverse sectional shapes as the respective raised portions 43, the ribs 42a likewise have the same transverse sectional shapes as the ribs 42b and the raised portions 43. Thus, the surface of each of the protrusion 41 is arcuately curved and forms a transverse sectional shape of each side of the protrusion 41 having a tapered face 45 that is inclined toward the distribution area 40. In addition, the protrusion 41 has a protruding dimension (the height dimension from the surface of the distribution area 40 where the spacer beads 31 are placed) of approximately 1.0 μm, while the protrusion 41 has a widthwise dimension (including the alignment layer 16) of approximately 10.0 μm.

In this second embodiment, the protrusions 41 are configured by the ribs 42a, 42b made of the same material as the raised portions 43. The ribs 42a, 42b therefore can be formed in the same process as the raised portions 43.

In addition, it is a concern that when the ink (not illustrated) containing the spacer beads 31 is applied to the CF substrate 20, the spacer beads 31 can rise up to the surfaces of the protrusion 41 (on the ribs 42a), as illustrated with an imaginary line in FIG. 5. However, in this embodiment, the surface of each of the protrusion 41 is arcuately curved and forms the transverse sectional shape of the each side of the protrusion 41 having the tapered face 45 that is inclined toward the distribution area 40. The spacer beads 31 which have risen up to the protrusion 41 are guided into the distribution area 40 by the tapered face 45, and therefore there is no such a concern that the spacer beads 31 could be left on the protrusion 41.

### Third Embodiment

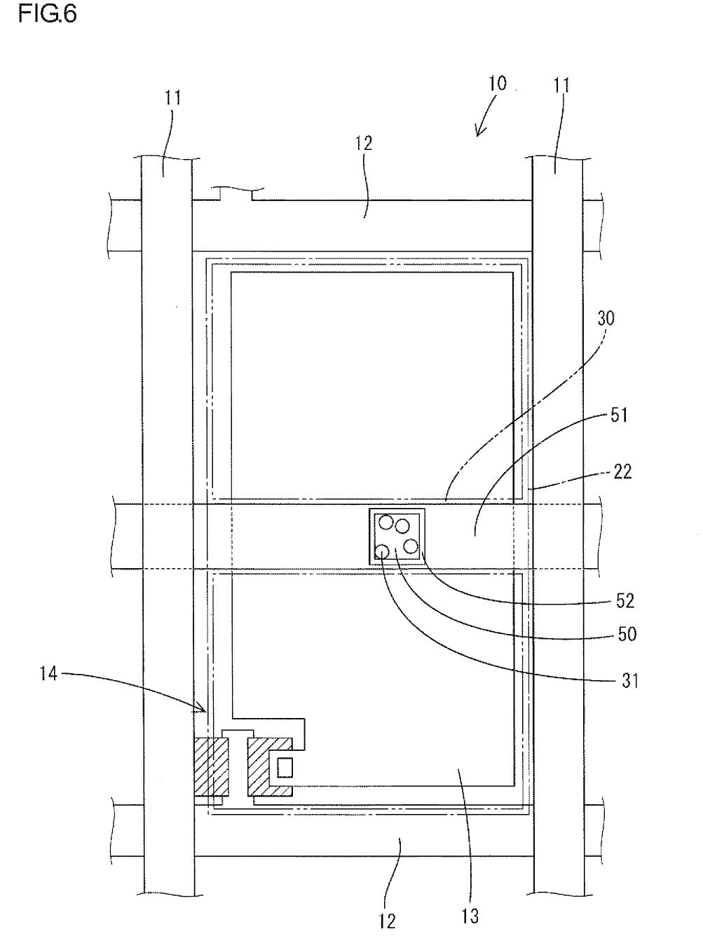

A third embodiment in accordance with the present invention will be now explained with reference to FIG. 6. In this third embodiment, distribution areas 50 are provided at different positions from those in the above first embodiment. Similar configurations to the first embodiment are designated by the same numerals, while explanations on the configurations, operations, and effects are omitted.

While a color filter 21 is configured on the CF substrate 20 by partitioning the colored portions 22 with the grid-patterned light shield black layer 23 (a black matrix) as described above, supplemental capacitor lines 51 are provided on the TFT substrate 10. The supplemental capacitor lines 51 are connected to the supplemental capacitors (storage or additional capacitors), and are provided in disposition to cross the colored portions 22. Areas that correspond to the supplemental capacitor lines 51 also constitute the light shield area 30. The distribution areas 50 and protrusions 52 are provided in the light shield area 30 and on the surface side (the opposed surface side to the CF substrate 20) of the supplemental capacitor lines 51. Each of the distribution areas 50 entirely encloses a whole periphery of respective one of the distribution areas 50. The planar shape of the protrusion 52 is plane square. That is, the supplemental capacitor lines 51 that are disposed across the colored portions 22 are utilized to dispose the spacer beads 31.

Note that, in this third embodiment, the supplemental capacitor lines 51 disposed across the colored portions 22 are utilized to provide the distribution areas 50. Instead of this, supplemental capacitor lines that do not cross the colored portions 22 may be utilized to provide the distribution areas.

### Other Embodiments

The present invention is not limited to the embodiments described above with reference to the drawings, the following embodiments are also included within the scope of the present invention.

(1) In the above first embodiment, each of the protrusion has a frame shape that entirely encloses the whole periphery of the respective one of the distribution area. Instead of this, the each protrusion may be a shape substantially enclosing the outer perimeter of the each distribution area, while being a discontinuous shape having partial gaps.

(2) In the above first embodiment, each of the protrusion has a square frame shape, however, the protrusion may have a rectangular, trapezoidal, parallelogram, circular, oval, elliptical, or the like shape.

(3) In the above first embodiment, the each protrusion is configured by the pair of ribs which are parallel to the longitudinal direction of the gate line and the pair of ribs which are parallel to the widthwise direction of the line. Instead of this, the protrusions may be configured by ribs that obliquely extend with respect to the longitudinal direction of the line.

(4) In the above first and third embodiments, the each protrusion is configured by ribs made of the same material as the source lines. However, the material may be the same as any one of the laminar layers, other than the source lines, provided on the TFT substrate.

(5) In the above first and third embodiments, the each protrusion is trapezoidal in cross section, however, the protrusion may be rectangular, square, semicircular, triangular, or the like in cross section.

(6) In the above second embodiment, the each protrusion is configured by ribs made of the same material as the raised portion. However, the material may be the same type as any one of the laminar layers, other than the raised portion, provided on the CF substrate.

(7) In the above second embodiment, the each protrusion is arcuately curved in cross section. Instead of this, the protrusion may be triangular, trapezoidal, rectangular, square, semicircular, or the like in cross section.

(8) In the above second embodiment, the planar shape of the each protrusion is rectangular frame shaped. However, the protrusion may be square, trapezoidal, parallelogram, circular, oval, elliptical, or the like shaped.

(9) In the second embodiment, the each protrusion is configured by disposing the four ribs into a generally rectangular shape having gaps at the four corners thereof. Instead of this, the protrusion may form a frame shape that entirely encloses the whole periphery of the distribution area.

(10) In the above second embodiment, the ribs which configure the two sides of the four sides of the each protrusion combine the raised portions. Instead of this, all of the four ribs constituting the protrusion may be independent from the raised portions.

(11) In the above embodiments, the protrusions (the ribs) are formed by photolithography process, however, not limited to this, for example, the protrusions (the ribs) may be formed by laser treatment.

(12) In the above embodiments, the distribution areas and the protrusions are disposed on the gate lines, on the light shield black layer, or on the supplemental capacitor lines. However, not limited to this, the distribution areas and the protrusions may be disposed on the source lines.

(13) In the above embodiments, the spacer beads are disposed on only either one of the TFT substrate and the CF substrate. However, the spacer beads may be disposed on both of the TFT substrate and the CF substrate. In this case, the spacer beads which are allocated on the TFT substrate and the spacer beads which are allocated on the CF substrate shall be disposed so as not to overlap and interfere with each other.

(14) In the above embodiments, cases where the TFT constitute the driving elements are explained. However, the present invention may be utilized also in cases where any elements other than TFT, such as MIM (metal insulator metal), constitute the driving elements.

1.-12. (canceled)

13. A liquid crystal display device, comprising:
two transparent substrates,
a spacer bead configured to hold the two transparent substrates at a desired distance;
liquid crystal that is sealed between the two transparent substrates;
a line that is formed on at least one of the two transparent substrates;
a distribution area that is provided on the line, the distribution area being an area where the spacer bead is disposed; and
a protrusion that has a square frame shape, the protrusion being provided on the line, wherein the protrusion encloses a periphery of the distribution area.

14. The liquid crystal display device according to claim 13, wherein the protrusion entirely encloses the periphery of the distribution area.

15. The liquid crystal display device according to claim 13, wherein the protrusion includes two first ribs that are substantially parallel to a longitudinal direction of the line and two second ribs that are substantially parallel to a widthwise direction of the line.

16. The liquid crystal display device according to claim 14, wherein the protrusion includes two first ribs that are substantially parallel to a longitudinal direction of the line and two second ribs that are substantially parallel to a widthwise direction of the line.

17. The liquid crystal display device according to claim 13, wherein the line is a gate line, the gate line having a surface side where the protrusion is disposed,
wherein the protrusion is made of material the same as a source line that cross the surface side of the gate line in overlapping relation.

18. The liquid crystal display device according to claim 14, wherein the line is a gate line, the gate line having a surface side where the protrusion is disposed,
wherein the protrusion is made of material the same as a source line that cross the surface side of the gate line in overlapping relation.

19. The liquid crystal display device according to claim 15, wherein the line is a gate line, the gate line having a surface side where the protrusion is disposed,
wherein the protrusion is made of material the same as a source line that cross the surface side of the gate line in overlapping relation.

20. The liquid crystal display device according to claim 16, wherein the line is a gate line, the gate line having a surface side where the protrusion is disposed,
wherein the protrusion is made of material the same as a source line that cross the surface side of the gate line in overlapping relation.

21. The liquid crystal display device according to claim 13, wherein the line is a supplemental capacitor line configured to be connected to a supplemental capacitor.

22. The liquid crystal display device according to claim 14, wherein the line is a supplemental capacitor line configured to be connected to a supplemental capacitor.

23. The liquid crystal display device according to claim 15, wherein the line is a supplemental capacitor line configured to be connected to a supplemental capacitor.

24. The liquid crystal display device according to claim 16, wherein the line is a supplemental capacitor line configured to be connected to a supplemental capacitor.

25. The liquid crystal display device according to claim 13, further comprising a color filter formed on one of the two transparent substrates, the color filter including a plurality of colored portions, the plurality of colored portions being allocated with being partitioned by a grid-patterned light shield black layer,
wherein the distribution area and the protrusion are disposed on the line that is disposed across the colored portions on another one of the transparent substrates.

26. The liquid crystal display device according to claim 14, further comprising a color filter formed on one of the two transparent substrates, the color filter including a plurality of colored portions, the plurality of colored portions being allocated with being partitioned by a grid-patterned light shield black layer,
wherein the distribution area and the protrusion are disposed on the line that is disposed across the colored portions on another one of the transparent substrates.

27. The liquid crystal display device according to claim 15, further comprising a color filter formed on one of the two transparent substrates, the color filter including a plurality of colored portions, the plurality of colored portions being allocated with being partitioned by a grid-patterned light shield black layer,
wherein the distribution area and the protrusion are disposed on the line that is disposed across the colored portions on another one of the transparent substrates.

28. The liquid crystal display device according to claim 16, further comprising a color filter formed on one of the two transparent substrates, the color filter including a plurality of colored portions, the plurality of colored portions being allocated with being partitioned by a grid-patterned light shield black layer,
wherein the distribution area and the protrusion are disposed on the line that is disposed across the colored portions on another one of the transparent substrates.

29. A liquid crystal display device, comprising:
two transparent substrates;
a spacer bead configured to hold the two transparent substrates at a desired distance;
liquid crystal sealed between the two transparent substrates;
a color filter disposed on one of the two transparent substrates;
a plurality of colored portions disposed on the color filter;
a grid-patterned light shield black layer disposed on the color filter, the grid-patterned light shield black layer partitioning the colored portions;
a distribution area disposed on the grid-patterned light shield black layer, the distribution area being an area where the spacer bead is disposed; and
a protrusion disposed on the grid-patterned light shield black layer, the protrusion having a square frame shape, wherein the protrusion encloses a periphery of the distribution area.

30. The liquid crystal display device according to claim 29, wherein the protrusion entirely encloses the periphery of the distribution area.

31. The liquid crystal display device according to claim 29, further comprising a raised portion that is formed on a liquid crystal side of the colored portions, the raised portion being formed by partially raising an alignment layer that is laminated on the liquid crystal side of the colored portions, the raised portion including an inclined surface that is inclined with respect to the one of the transparent substrates,
wherein the protrusion includes a rib, the rib being made of the same material as the raised portion.

32. The liquid crystal display device according to claim 30, further comprising a raised portion that is formed on a liquid crystal side of the colored portions, the raised portion being formed by partially raising an alignment layer that is laminated on the liquid crystal side of the colored portions, the raised portion including an inclined surface that is inclined with respect to the one of the transparent substrates,
wherein the protrusion includes a rib, the rib being made of the same material as the raised portion.

33. The liquid crystal display device according to claim 29, wherein a surface of the protrusion is arcuately curved and thereby forms a cross sectional shape of the protrusion that includes a tapered face downwardly inclined toward the distribution area.

34. The liquid crystal display device according to claim 30, wherein a surface of the protrusion is arcuately curved and thereby forms a cross sectional shape of the protrusion that includes a tapered face downwardly inclined toward the distribution area.

35. The liquid crystal display device according to claim 31, wherein a surface of the protrusion is arcuately curved and thereby forms a cross sectional shape of the protrusion that includes a tapered face downwardly inclined toward the distribution area.

36. The liquid crystal display device according to claim 32, wherein a surface of the protrusion is arcuately curved and thereby forms a cross sectional shape of the protrusion that includes a tapered face downwardly inclined toward the distribution area.

37. A method of manufacturing a liquid crystal display device, the method comprising the steps of:
forming a protrusion on a surface of at least one of two transparent substrates, the surface being opposed to another one of the transparent substrates;
applying ink containing a spacer bead into a distribution area, a substantially entire periphery of the distribution area being enclosed with the protrusion;
vaporizing the ink, thereby securing the spacer bead to the distribution area;
assembling the two transparent substrates with holding the spacer bead therebetween and thereby providing a desired distance therebetween, thereby defining a space therebetween; and
dispensing or sealing liquid crystal in the space between the two transparent substrates.
